(19) United States
(12) Patent Application Publication
(10) Pub. No.: US 2017/0034252 A1
(43) Pub. Date: Feb. 2, 2017

(54) MASTERLESS WEBSOCKET SERVER SYSTEM

(71) Applicant: Fuhu, Inc., El Segundo, CA (US)

(72) Inventor: Ya-Te Wong, El Segundo, CA (US)

(73) Assignee: Fuhu, Inc., El Segundo, CA (US)

(21) Appl. No.: 14/815,882

(22) Filed: Jul. 31, 2015

(51) Int. Cl. H04L 29/08; H04L 5/14; H04L 29/12; H04L 29/06

(52) U.S. Cl. CPC H04L 67/10; H04L 69/16; H04L 5/14; H04L 61/2007

(57) ABSTRACT

A masterless WebSocket server system is disclosed. According to one embodiment, the masterless WebSocket server system includes a plurality of client computers, and a plurality of servers connected to the plurality of client computers over a network. The plurality of servers include a first number of SEED servers and a second number of non-SEED servers and the plurality of servers communicate and exchange network connectivity information with each other through gossip communication.

### FIELD

The present disclosure generally relates to a server system, and more particularly, to a masterless WebSocket server system.

### BACKGROUND

As the development and use of servers supporting full-duplex communication (e.g., WebSocket servers) continues to grow, a significant limitation exists in that the widely used master-slave model for communication among such servers (e.g., WebSocket servers) supporting communication through load balancers. The master-slave model generally relies on a load balancer to distribute workloads across clients using slave servers. If for any reason the load balancer is down, the entire system may suffer from slow network performance, or an overloaded server may eventually crash. Such a single point of failure makes the master-slave model unreliable for high performance applications. Additionally, in case of WebSocket servers using the master-slave model, the number of WebSocket connections that a WebSocket server can accept is limited by the available ephemeral ports in the load balancer. However, in some embodiments, hardware can be used to overcome the problem of limited availability of the ephemeral ports in the load balancer. In another embodiment, an ephemeral port can be defined as a short-lived transport protocol port for Internet Protocol (IP) communications allocated automatically from a predefined range by the IP software.

### SUMMARY

A masterless WebSocket server system is disclosed. According to one embodiment, the masterless WebSocket server system includes a plurality of client computers; and a plurality of servers connected to the plurality of client computers over a network. The plurality of servers include a first number of SEED servers and a second number of non-SEED servers, and the plurality of servers communicate and exchange network connectivity information with each other through gossip communication.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The accompanying drawings, which are included as part of the present specification, illustrate the various embodiments of the present disclosed system and method and together with the general description given above and the detailed description of the preferred embodiment given below serve to explain and teach the principles of the present disclosure.

FIG. 1 illustrates a prior art master-slave server system;

FIG. 2 illustrates another prior art master-slave server system with fault tolerance;

FIG. 3A illustrates an exemplary masterless WebSocket server system, according to one embodiment;

FIG. 3B illustrates another exemplary masterless WebSocket server system, according to one embodiment;

FIG. 4 illustrates a learning process of servers via gossip communication;

FIG. 5A illustrates an exemplary masterless WebSocket server system, according to one embodiment.

FIG. 5B illustrates a learning process of servers via gossip communication, according to one embodiment.

FIG. 6 illustrates a masterless WebSocket server system including a plurality of WebSocket servers, according to one embodiment;

FIGS. 7A-7B illustrate an exemplary process of adding a WebSocket server in a masterless WebSocket server system, according to one embodiment; and

FIG. 8 illustrates an exemplary process of eliminating a down server from a masterless WebSocket server system, according to one embodiment.

It should be noted that the figures are not necessarily drawn to scale and that elements of structures or functions are generally represented by reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A masterless WebSocket server system is disclosed. According to one embodiment, the masterless WebSocket server system includes a plurality of client computers; and a plurality of servers connected to the plurality of client computers over a network. The plurality of servers include a first number of SEED servers and a second number of non-SEED servers, and the plurality of servers communicate and exchange network connectivity information with each other through gossip communication.

In the following description, for purposes of clarity and conciseness of the description, not all of the numerous components shown in the schematic are described. The numerous components are shown in the drawings to provide a person of ordinary skill in the art a thorough enabling disclosure of the present system and method. The operation of many of the components would be understood to one skilled in the art.

Each of the additional features and teachings disclosed herein can be utilized separately or in conjunction with other features and teachings to provide a detachable frame for a mobile computer. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the present disclosure. Therefore, combinations of features disclosed in the following detailed description may not be necessary to practice the teachings in the broadest sense and are instead taught merely to describe particularly representative examples of the present teachings.

Moreover, various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples.

In one embodiment, gossip communication can be defined as a communication protocol involving periodic, pairwise, inter-process interactions.

In one embodiment, a WebSocket server can be defined as a server that provides full-duplex communication on channels over a single transmission control protocol (TCP) connection. A TCP socket is uniquely identified by the four values (client IP, client port, server IP and server port). Port number is a 16-bit unsigned integer (64K). Full-duplex communication allows for simultaneous communication in both directions.

A masterless WebSocket server system can be made scalable to accept a large number of concurrent WebSocket connections without relying on a load balancer. By incorporating SEED servers and gossip communication, the masterless WebSocket server system can better utilize each server's resources without a single point of failure.

In one embodiment, SEED servers represent a set of servers that all servers in a masterless WebSocket server system know about initially. In term of applications running on the server machines, SEED servers are similar to the non-seed servers. However, in a masterless WebSocket server system, the domain name and/or static IP address of the SEED servers are known to all servers in the system. The number of SEED servers defines the masterless WebSocket server system fault tolerance level. Additionally, the SEED servers bootstrap the gossip communication process because they are known contact points for the other servers in the server system.

SEED servers are the initial contact points of the masterless WebSocket server system. When one or more additional WebSocket server is added to the masterless WebSocket server system, it initially contacts the SEED servers to participate in the gossiping process. Unless all the SEED servers in the system are down at the same time, the newly added server contacts one of them. Accordingly, the total number of SEED servers defines the fault tolerance level of the masterless WebSocket server system. The total number of servers in the masterless WebSocket server system also contributes in determining the fault tolerance level of the masterless WebSocket server system.

In the masterless WebSocket server system the number of WebSocket connections that a WebSocket server can accept is not limited by the number of available ephemeral ports. In this case, the definition of a TCP socket governs the limitation. Without the presence of a load balancer, clients come from all over the Internet and they all have different client IP addresses, thus the ephemeral ports limitation is not an issue.

However, in some embodiments, if the setup consists of a WebSocket server sitting behind a load balancer, then there is an inherent limit on how many TCP/IP or WebSocket connections can be open at the same time from the load balancer to a specific port of that WebSocket server. In this case, the load balancer acts as the client and the WebSocket server acts as the server. Moreover, in this case, it is assumed that the server IP, server port and client IP (load balancer's IP) are fixed, whereas the only variable is the client port which has a 64K limit. Therefore, even if the WebSocket server itself has the resource to keep 100K WebSocket connections open, if the ports of the load balancer are exhausted, then the load balancer cannot create any additional connections to the WebSocket server. However, if there are multiple WebSocket servers sitting behind the load balancer, the 64K limit applies to each load balancer-to-WebSocket server pair.

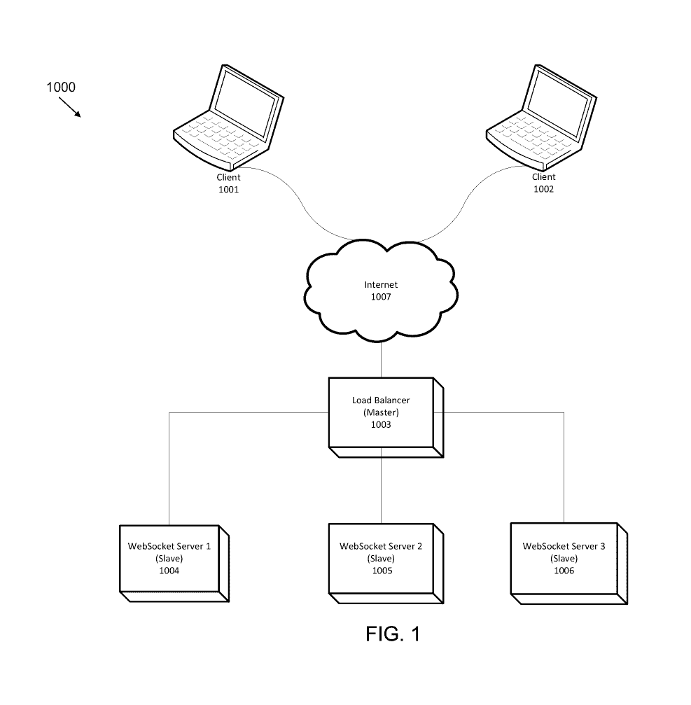

FIG. 1 illustrates a prior art master-slave server system including a plurality of client computers, a load balancer, and a plurality of slave WebSocket servers. In the master-slave server system 1000, the client computers 1001 and 1002 connect to the load balancer 1003 (or a master) over a network 1007 (e.g., the Internet). The load balancer 1003 distributes the WebSocket connections among the plurality of slave WebSocket servers 1004, 1005 and 1006. Due to this reason, if the load balancer 1003 is down, the entire master-slave server system 1000 suffers from slow network performance. Such a single point of failure makes the master-slave server system 1000 unreliable for high performance applications.

In the master-slave server system 1000, the client computers 1001 and 1002 are not allowed to choose a slave WebSocket server (e.g., 1004, 1005 or 1006). The load balancer 1003 chooses the right slave WebSocket server for a client computer (1001 or 1002) based on a load-balancing algorithm (e.g. round robin). However, due to the load balancer 1003's limited knowledge about the servers, a slave WebSocket server (e.g., 1004, 1005 or 1006) that is chosen for a particular client computer may not be suitable for that client computer (1001 or 1002). Additionally, in the master-slave server system 1000, the number of WebSocket connections that a WebSocket server 1004, 1005 or 1006 can accept is limited by the available number of ephemeral ports in the load balancer 1003.

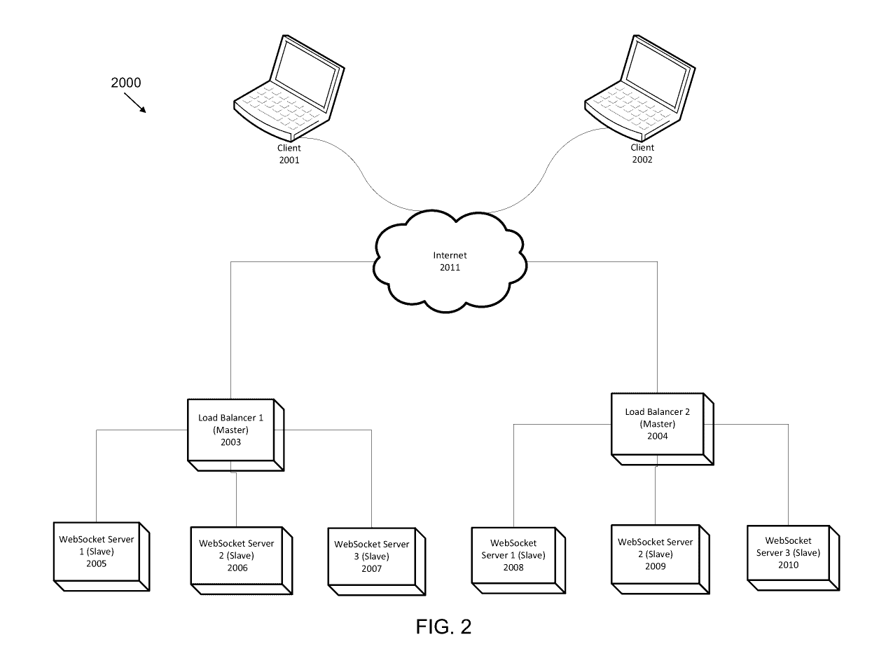

FIG. 2 illustrates another prior art master-slave server system with fault tolerance. The master-slave server system 2000 includes a plurality of client computers 2001 and 2002, two load balancers 2003 and 2004, and a plurality of slave WebSocket servers 2005-2010. The client computers 2001 and 2002 connect to the load balancers 2003 and 2004 over a network 2011 (e.g., the Internet), and the load balancers 2003 and 2004 distribute the WebSocket connections among the plurality of slave WebSocket servers 2005-2010. A client computer (e.g., 2001 or 2002) does not choose a WebSocket server for itself. Each client computer (e.g., 2001 or 2002) randomly chooses a load balancer (e.g., 2003 or 2004) to connect to. Each load balancer (e.g. 2003 or 2004) chooses one of the slave WebSocket servers for each client computer (2001 or 2002) based on a load-balancing algorithm (e.g., round robin). However, due to the load balancers' 2003 and 2004 limited knowledge about the servers 2005-2010, the slave WebSocket server (e.g., 2005-2010) that is chosen for a particular client computer may not be the most suitable for that client computer (2001 or 2002). Here, the most suitable slave WebSocket server is the least utilized slave WebSocket server.

Unlike the master-slave server system 1000, if one of the load balancers 2003 or 2004 of the master-slave server system 2000 is down, the other functional load balancer distributes the load among the slave WebSocket servers 2005-2010. Therefore, the presence of multiple load balancers 2003 and 2004 in the master-slave server system 2000 achieves better fault tolerance and reliability than the master-slave server system 1000. However, similar to the master-slave server system 1000, the number of WebSocket connections that a slave WebSocket server 2005-2010 can accept is limited by the available number of ephemeral ports in the load balancer 2003 or 2004.

Alternatively, in some embodiments, based on its needs, a single client computer can connect to multiple load balancers at the same time since a computer can run multiple applications and each application can create multiple WebSocket connections.

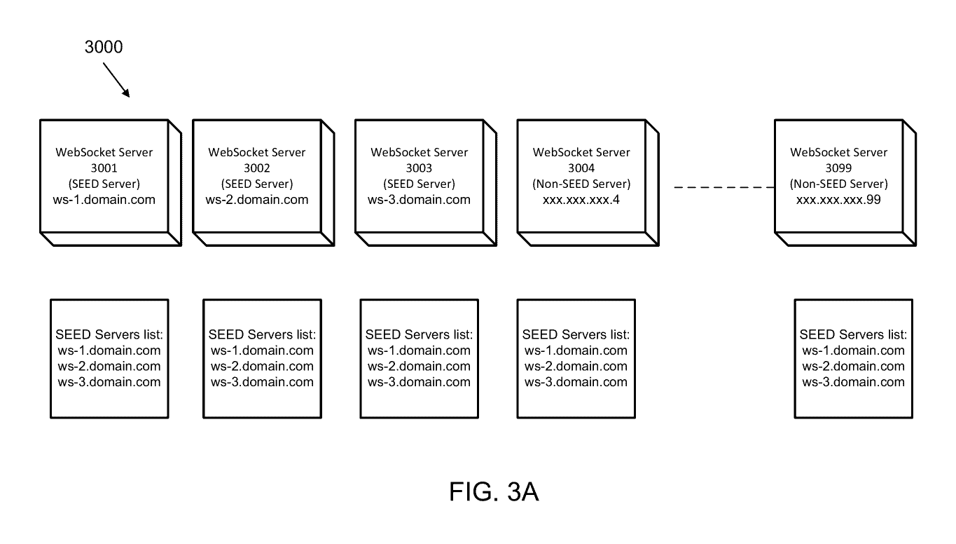

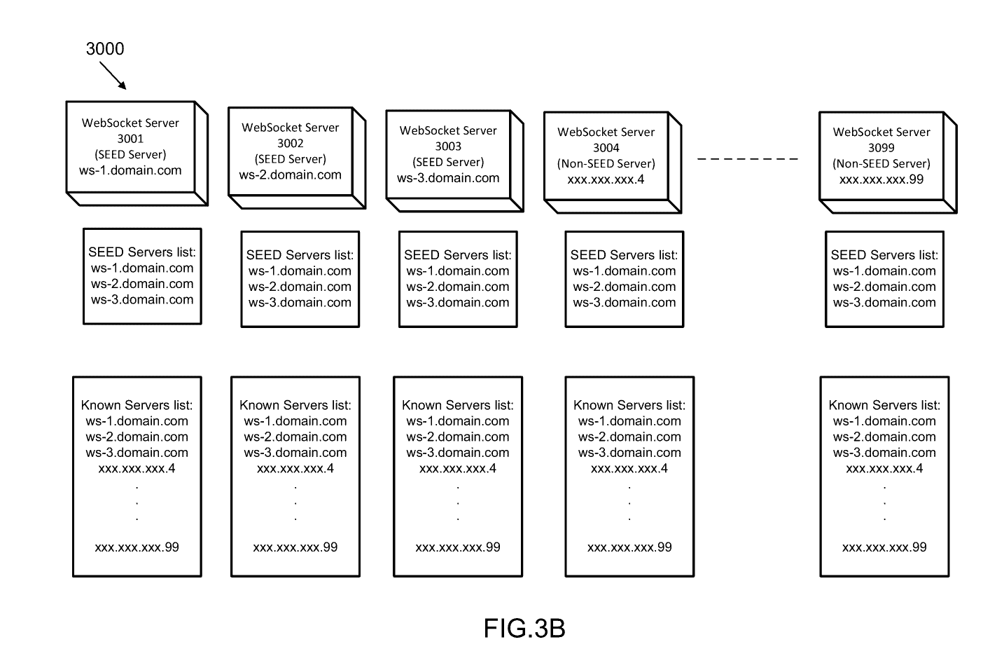

FIG. 3A illustrates an exemplary masterless WebSocket server system, according to one embodiment. More particularly, FIG. 3A illustrates an exemplary state of the WebSocket servers in a masterless WebSocket server system prior to gossip communication among the servers. The masterless WebSocket server system 3000 includes a plurality of WebSocket servers 3001-3099. The total number of WebSocket servers shown in FIG. 3A is ninety-nine. However, a person skilled in the art would understand that the masterless WebSocket server system 3000 can include any number of WebSocket servers.

The masterless WebSocket server system 3000 has at least two SEED servers to execute the gossip communication process. In the example shown in FIG. 3A, the servers 3001-3003 are designated as SEED servers and servers 3004-3099 are designated as non-SEED servers. The total number of SEED servers 3001-3003 in the masterless WebSocket server system 3000 determines the system's fault tolerance level.

With respect to running applications, SEED servers 3001-3003 are similar to the non-seed servers 3004-3099, except that each one of the SEED server's domain name and/or static IP address is known to the rest of the servers in the masterless WebSocket server system 3000. Initially, each server 3001-3099 in the masterless WebSocket server system 3000 knows only the domain name and/or static IP address of the SEED servers 3001-3003.

According to one embodiment, the servers 3001-3099 in the masterless WebSocket server system 3000 randomly and periodically exchange information with each other through gossip communication. Gossip communication is a computer-to-computer communication protocol with periodic, pairwise and inter-process interaction. Through gossip communication, the servers 3001-3099 (either SEED or non-SEED servers) talk to each other randomly and periodically and exchange information about the states of the servers in the masterless WebSocket server system 3000.

Each server 3001-3099 in the masterless WebSocket server system 3000 initially begins a gossip communication process by building a knowledge base of the system with the knowledge of the SEED servers, including, but not limited to, domain names and/or static IP address. The knowledge base of a server further includes, but is not limited to, a list of servers in the masterless WebSocket server system 3000, server IP address, server port number, server domain name and server resource utilization. The knowledge base of a server represents that server's view of the entire system. In some embodiment, the knowledge base can be stored in system memory for faster reads/writes or can be stored on disk if the system has some constraints.

Continuing with the example of FIG. 3A, during the gossip communication process, each server 3001-3099 also gathers pertinent information about itself (e.g., available memory, the number of connected WebSocket servers) and saves the information to its knowledge base of the entire system. Each server 3001-3099 randomly selects one or more other servers it knows about and sends its latest knowledge base information of the entire system to the selected server(s). Each server that has received knowledge base information from another server combines the received knowledge base information to its own knowledge base of the entire system and returns the combined knowledge base to the sending server. The sending server receives the data and merges it to its knowledge base of the entire system. These four steps are carried out by each server in the masterless WebSocket server system 3000 periodically and independently. As the gossip communication process continues among the servers 3001-3099, each server in the masterless WebSocket server system 3000 gradually learns about the existence of other servers and eventually knows the states of all other servers (e.g., available system memory, CPU usage, and number of WebSocket connections, and the like) in the masterless WebSocket server system 3000. The information exchanged by a pair of servers includes, but not limited to, server domain name, server IP address, server listening port number, server resource utilization metrics, and the like.

FIG. 3B illustrates an exemplary state of the WebSocket servers in the masterless WebSocket server system of FIG. 3A after the completion of the gossip communication process among the servers, according to one embodiment. Beginning with the information known to SEED servers 3001-3003, each of the servers 3001-3099 gradually learns about the status of initially unknown servers in the masterless WebSocket server system 3000 via the gossip communication among the servers 3001-3099. At the end of the gossip communication process, each server in the masterless WebSocket server system 3000 learns about the states of all other servers 3001-3099 in the masterless WebSocket server system 3000. The learning process of the servers 3001-3099 by gossip communication may occur randomly and independently based on available information and the network connectivity of a server in the masterless WebSocket server system 3000. Therefore, the speed and completeness of the learning may vary depending on the server.

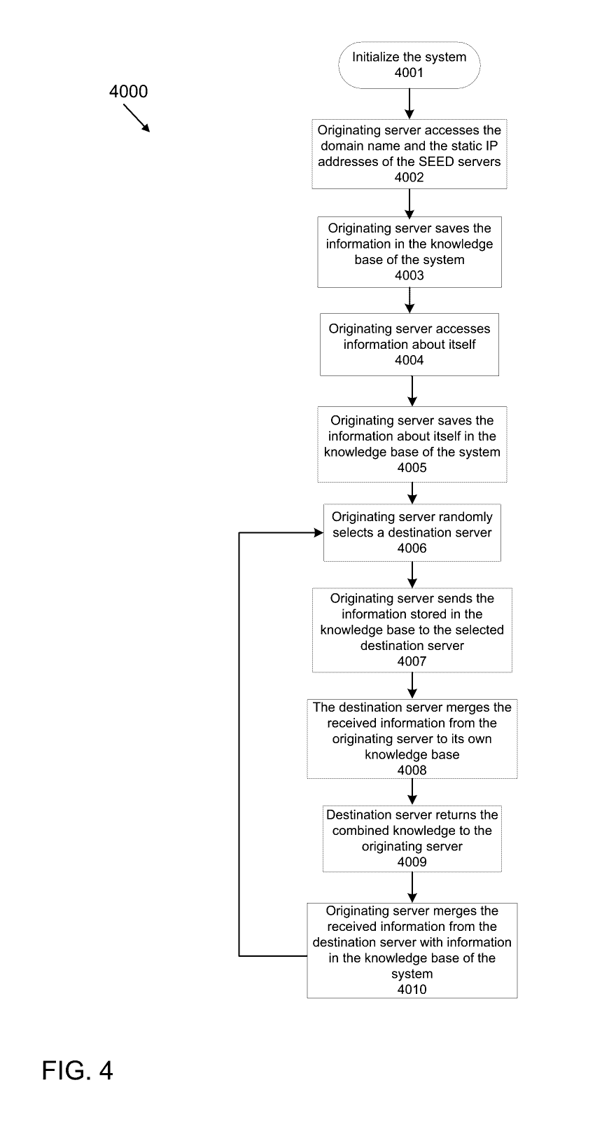

FIG. 4 illustrates a learning process of servers via gossip communication. More particularly, FIG. 4 illustrates a gossip communication process 4000 with respect to a server in the masterless WebSocket server system 3000.

Beginning at step 4001, the masterless WebSocket server system 3000 is initialized to perform the gossip communication process 4000. At step 4002, an originating server (e.g., 3004) accesses the domain names and/or static IP address of the one or more SEED servers (e.g., 3001, 3002, 3003) in the masterless WebSocket server system 3000. Next, at step 4003 the originating server (e.g., 3004) saves the information regarding the SEED servers (e.g., 3001, 3002, 3003) to a knowledge base of the system. At step 4004, the originating server (e.g., 3004) accesses information about itself (e.g., available memory, the number of connected WebSocket servers and the like) and at step 4005, the originating server (e.g., 3004) saves such information to the knowledge base of the system.

At step 4006, the originating server (e.g., 3004) randomly selects a destination server (e.g., 3099) from a server list, stored in the knowledge base of the system. Next, at step 4007, the originating server (e.g., 3004) sends its latest knowledge base information of the system to the selected destination server (e.g., 3099). At step 4008, the destination server (e.g., 3099) merges the received knowledge base information to its own knowledge base of the system. At step 4009, the destination server (e.g., 3099) returns the combined knowledge to the originating server (e.g., 3004).

Next, at step 4010, the originating server (e.g., 3004) receives the knowledge base information from the destination server (e.g., 3099) and merges the received information to its own knowledge base. From 4010, the gossip communication process 4000 returns to step 4006 and continues. The gossip communication process continues for as long as it is intend to run the masterless WebSocket servers system 3000. This is necessary to pick up changes in the system 3000, such as, new servers, down servers and state changes in each server.

The gossip communication process 4000 is carried out by each server (e.g. 3001-3099) in the masterless WebSocket server system 3000 periodically and independently. As the gossip communication process 4000 continues among the servers 3001-3099, each server in the masterless WebSocket server system 3000 gradually learns about the existence of other servers and eventually knows the states of all other servers in the masterless WebSocket server system 3000.

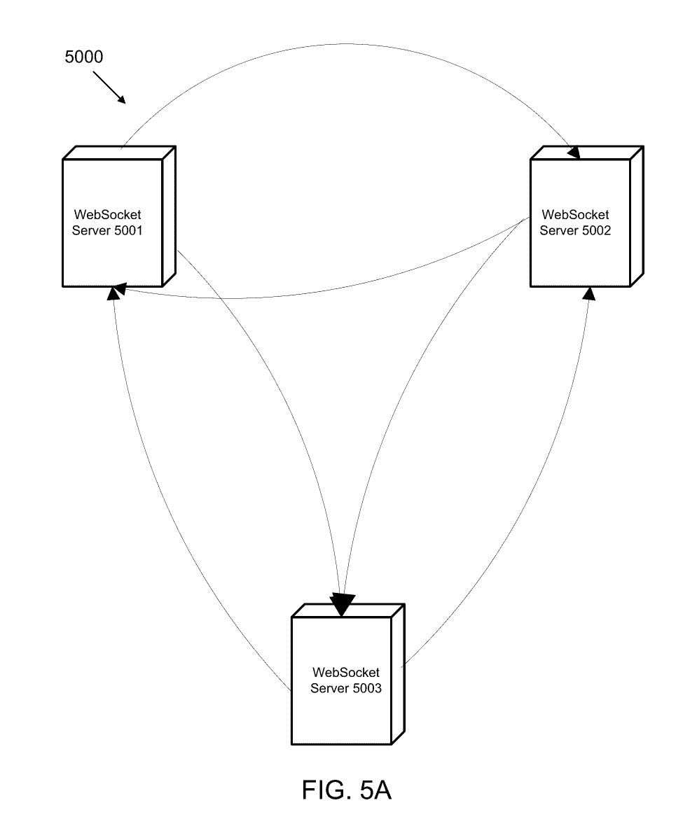

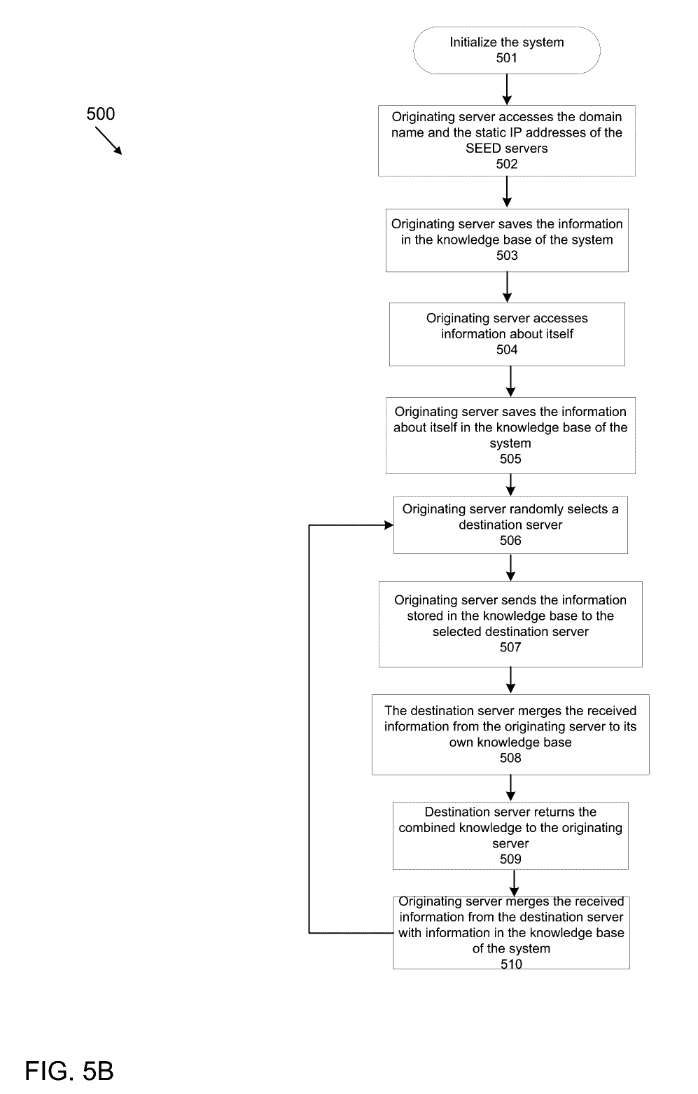

FIG. 5A illustrates an exemplary masterless WebSocket server system 5000, according to one embodiment. The masterless WebSocket server system 5000 includes three WebSocket servers 5001, 5002 and 5003. However, a person skilled in the art would understand that the masterless WebSocket server system 5000 can include any number of WebSocket servers.

The masterless WebSocket server system 5000 has two SEED servers 5001 and 5002 and a non-SEED server 5003 to execute the gossip communication process. Initially, each server 5001-5003 in the masterless WebSocket server system 5000 knows only the domain name and/or static IP address of the SEED servers 5001-5002. The servers 5001-5003 in the masterless WebSocket server system 5000 randomly and periodically exchange information with each other through gossip communication.

Each server (e.g. 5001, 5002 and 5003) in the masterless WebSocket server system 5000 begins the gossip communication process by building a knowledge base of the system with the knowledge of the SEED servers (e.g. 5001, 5002) including, but not limited to their domain names and/or static IP address. Each server (e.g. 5001, 5002 and 5003) also gathers pertinent information about itself (e.g., available memory, the number of connected WebSocket servers and the like) and saves the information to the knowledge base of the system. Next, each server (e.g. 5001, 5002 and 5003) randomly selects one or more other servers from a server list in the knowledge base and sends its latest knowledge base information of the entire system to the selected server(s).

Each server that has received knowledge base information from another server merges the received knowledge base information to its own knowledge base of the system and returns the merged knowledge base to the server from which the knowledge base information was received. This gossip communication process is carried out by each server in the masterless WebSocket server system 5000 periodically and independently. As the gossip communication process continues among the servers 5001-5003, each server in the masterless WebSocket server system 5000 gradually learns about the existence of other servers and eventually knows the states of all other servers in the masterless WebSocket server system 5000.

FIG. 5B illustrates a learning process of servers via gossip communication. More particularly, FIG. 5B illustrates a gossip communication process 500 with respect to a server in the masterless WebSocket server system 5000.

Beginning at step 501, the masterless WebSocket server system 5000 is initialized to perform the gossip communication process 500. At step 502, an originating server (e.g., 5003) accesses the domain names and/or static IP address of the one or more SEED servers (e.g., 5001, 5002) in the masterless WebSocket server system 5000. Next, at step 503 the originating server (e.g., 5003) saves the information regarding the SEED servers (e.g., 5001, 5002) to a knowledge base of the system. At step 504, the originating server (e.g., 5003) accesses information about itself (e.g., available memory, the number of connected WebSocket servers and the like) and at step 505, the originating server (e.g., 5003) saves such information to the knowledge base of the system.

At step 506, the originating server (e.g., 5003) randomly selects a destination server (e.g., 5001) from a server list, stored in the knowledge base of the system. Next, at step 507, the originating server (e.g., 5003) sends its latest knowledge base information of the system to the selected destination server (e.g., 5001). At step 508, the destination server (e.g., 5001) merges the received knowledge base information to its own knowledge base of the system. At step 509, the destination server (e.g., 5001) returns the combined knowledge to the originating server (e.g., 5003).

Next, at step 510, the originating server (e.g., 5003) receives the knowledge base information from the destination server (e.g., 5001) and merges the received information to its own knowledge base. From 510, the gossip communication process 500 returns to step 506 and continues. The gossip communication process continues for as long as it is intend to run the masterless WebSocket servers system 5000. This is necessary to pick up changes in the system 5000, such as, new servers, down servers and state changes in each server.

The gossip communication process 500 is carried out by each server (e.g. 5001-5003) in the masterless WebSocket server system 5000 periodically and independently. As the gossip communication process continues among the servers 5001-5003, each server in the masterless WebSocket server system 5000 gradually learns about the existence of other servers and eventually knows the states of all other servers in the masterless WebSocket server system 5000.

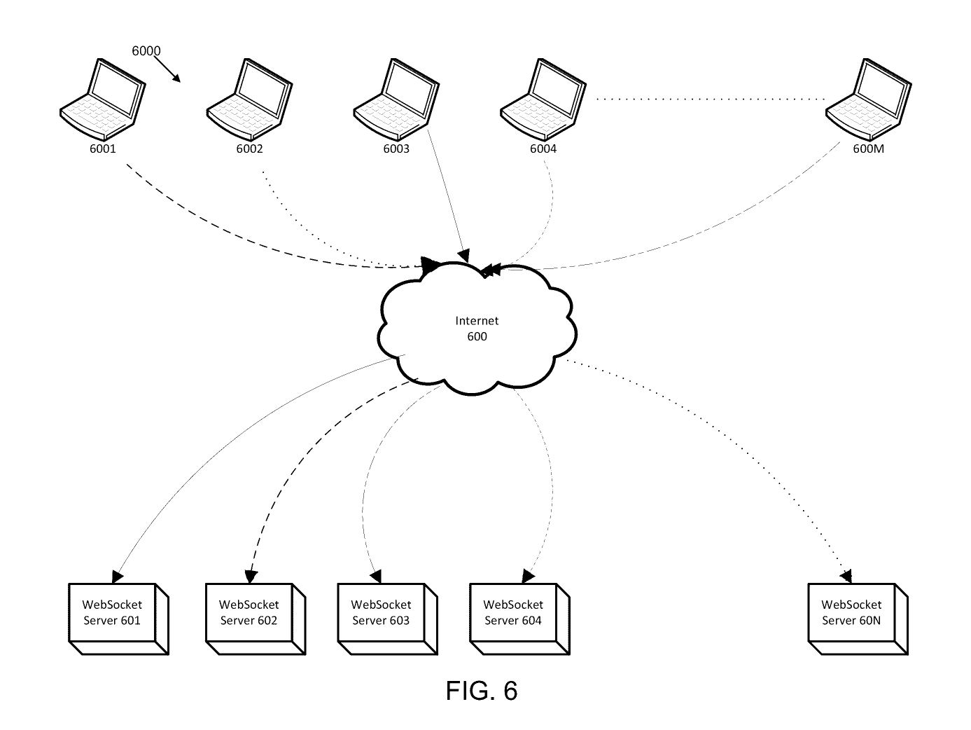

FIG. 6 illustrates another exemplary masterless WebSocket server system, according to one embodiment. The masterless WebSocket server system 6000 includes N (e.g., 601-60N) WebSocket servers connected to M (e.g., 6001-600M) client computers over a network 600 (e.g., the Internet). All servers 601-60N randomly and periodically exchange information with each other through gossip communication. In this example, servers 601-603 are SEED servers, and servers 604-60N are non-SEED servers. Initially, every server 601-60N knows only the domain name and/or static IP address of the SEED servers 601-603. As the gossip communication process continues among the servers 601-60N, each server gradually learns about other servers and eventually knows the states of all other servers in the masterless WebSocket server system 6000.

At any time, each server 601-60N in the masterless WebSocket server system 6000 can be connected to zero, one or more client computers 6001-600M over a network 600 (e.g., the Internet). However, in some embodiments, at any time, each server 601-60N in the masterless WebSocket server system 6000 may not be connected to any client computers 6001-600M. All servers 601-60N in the masterless Web Socket server system 6000 provide application program interface (API) for the client computers 6001-600M. Initially, the client computers 6001-600M only know the domain name and/or static IP address of the SEED servers 601-603. Through the gossip communication and the API provided by the servers 601-60N, the client computers 6001-600M learn about the state of all the servers 601-60N in the masterless WebSocket server system 6000 and accordingly select the best server to connect to. For example, a client computer (e.g., 6001-600M) prefers to select a server that has the lowest resources utilization. Resources can include, but are not limited to, CPU, memory, network bandwidth, and the like.

When a server (e.g., 601) in the masterless WebSocket server system 6000 is down, the other servers (e.g., 601-60N) in the system 6000 learns about the down server through gossip communication and each of the other servers (e.g., 602-60N) updates its knowledge base of the entire system accordingly. Because the client computer (e.g., 6001-600M) can use the API to access the knowledge base of the entire system, the client computer (e.g., 6001-600M) can avoid attempting to connect to the down server (e.g., 601) proactively instead of relying on a trial-and-error process. and select a healthy server to work with.

Through SEED servers and gossip communication, the client computers 6001-600M in the masterless WebSocket server system 6000 can successfully communicate with the WebSocket servers without a load balancer, as needed in the master-slave server system 1000 or 2000. Further, unlike the master-slave server system 1000 or 2000, the absence of a load balancer in the masterless WebSocket server system 6000 eliminates a single point of failure in the system and enhances the reliability of the system. Moreover, since client computers 6001-600M in the masterless WebSocket server system 6000 have different IP addresses, the number of WebSocket connections that a WebSocket server can accept is not limited by the number of available ephemeral ports of the load balancer.

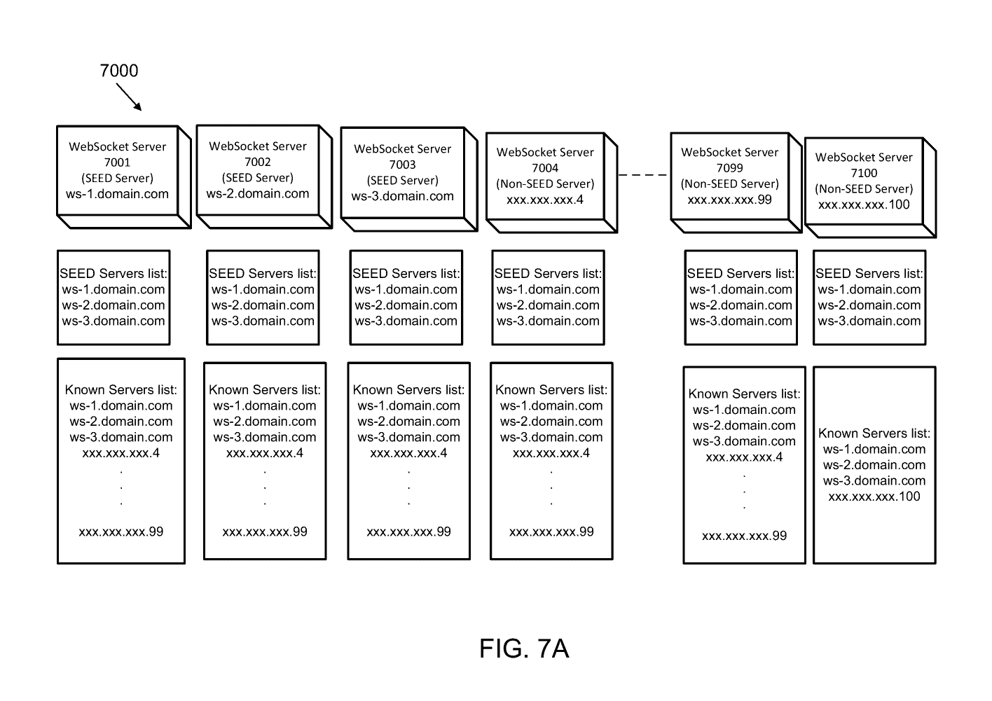

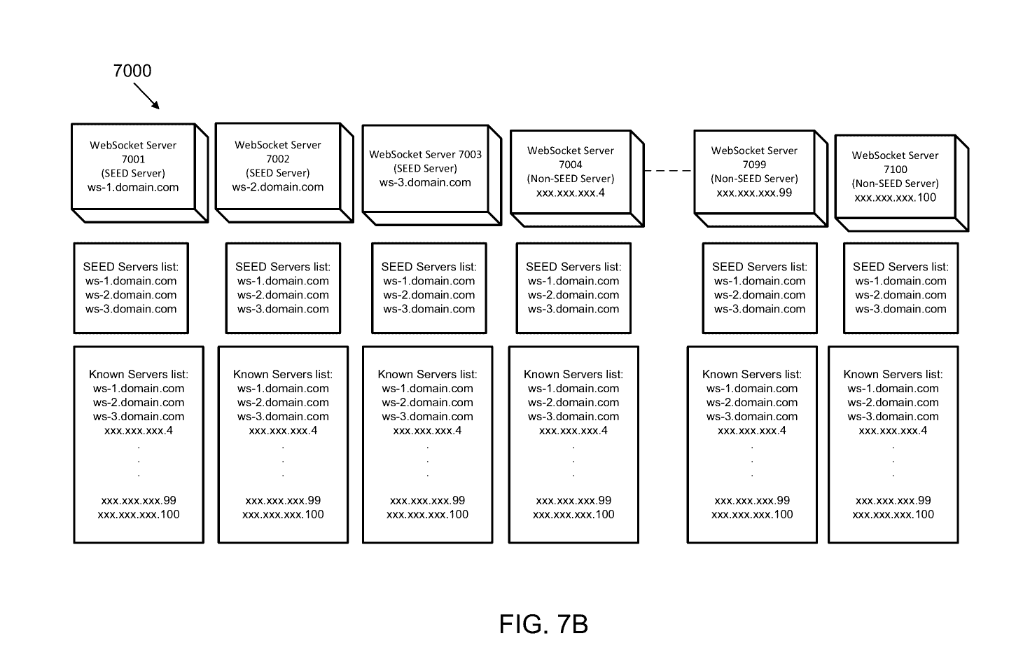

FIGS. 7A-7B illustrate an exemplary process of adding a WebSocket server in a masterless WebSocket server system, according to one embodiment. The masterless WebSocket server system 7000 includes ninety-nine WebSocket servers 7001-7099. In this example, servers 7001-7003 are designated as SEED servers, and servers 7004-7099 are designated as non-SEED servers. Initially, every server 7001-7099 knows only the domain name and/or IP address of the SEED servers 7001-7003. All servers 7001-7099 randomly and periodically exchange their knowledge base through gossip communication.

As the gossip communication process continues between the servers 7001-7099, each server in the masterless WebSocket server system 7000 gradually learns about the existence of other servers and eventually knows the states of all other servers in the masterless WebSocket server system 7000. A server 7100 that is newly added initially communicates with the SEED servers and obtains the knowledge of the SEED servers (e.g., the domain name and/or static IP address). Once added, the new server 7100 eventually knows the states of all other servers in the masterless WebSocket server system 7000 via the gossip communication processes.

As illustrated in FIG. 7A, the new server 7100 starts the process of getting added to the masterless WebSocket server system 7000 only with the knowledge of the domain names and/or static IP address of three SEED servers 7001-7003. The new server 7100 gathers pertinent information about itself (e.g., available memory, number of connected WebSocket servers and the like) and saves the information to the knowledge base of the system. Next, the new server 7100 randomly selects one or more other servers from a server list in the knowledge base, and sends its latest knowledge base information of the system to the selected server(s). Each server that has received knowledge base information from the new server 7100 merges the received information to its own knowledge base of the system and returns the combined knowledge base back to the new server 7100. This process is carried out by each server 7001-7100 in the masterless WebSocket server system 7000 periodically and independently. As the process continues between the new server 7100 and the existing servers 7001-7099, each server in the masterless WebSocket server system 7000 gradually learns about the existence of the new server 7100. However, it is not necessary for the new server 7100 to directly contact every other server 7001-7099 in the masterless WebSocket server system 7000 to announce its presence. Once the new server 7100 communicates with one or more other servers (e.g. 7001, 7002), the other servers (e.g. 7001, 7002) can help “spread the word”.

FIG. 7B illustrates the completion of the gossip communication process for the new server 7100 in the masterless WebSocket server system 7000. Once the gossip communication process is completed, the new server 7100 knows the status of all the other servers 7001-7099 and all the other servers 7001-7099 knows the status of the new server 7100.

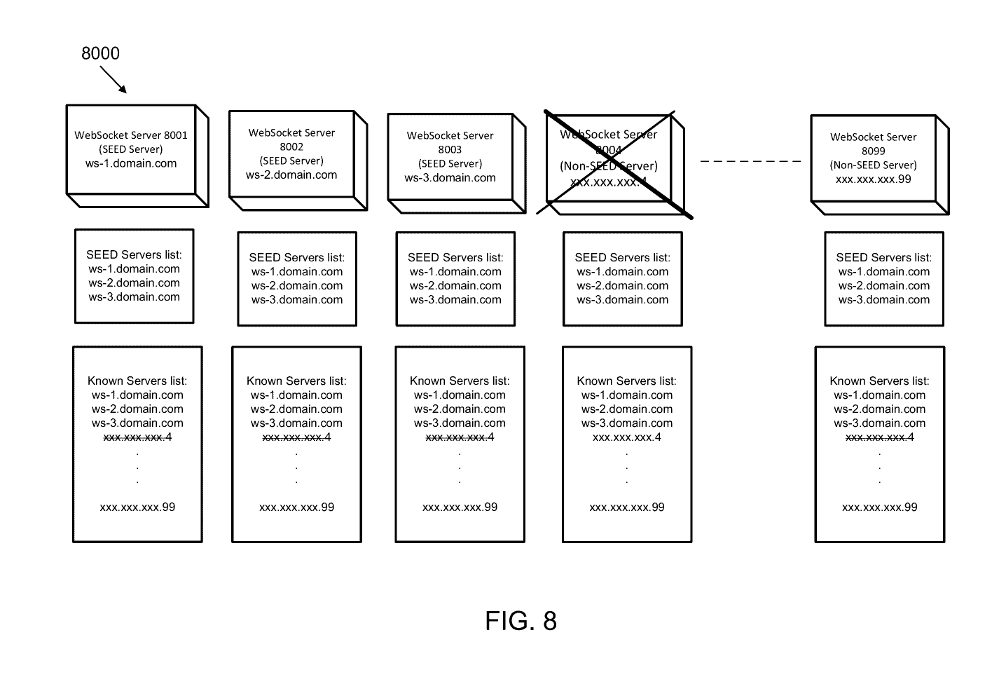

FIG. 8 illustrates an exemplary process of eliminating a down server from a masterless WebSocket server system, according to one embodiment. The masterless WebSocket server system 8000 includes ninety-nine WebSocket servers 8001-8099. The servers 8001-8003 are designated as SEED servers, and servers 8004-8099 are non-SEED servers. The servers 8001-8099 randomly and periodically exchange their knowledge base among each other through gossip communication. If one of the WebSocket servers (e.g., server 8004) of the masterless WebSocket server system 8000 is down, the down server 8004 stops initiating gossip communication. In such case, other running WebSocket servers (e.g., the SEED servers 8001-8003 and non-SEED servers 8005-8099) attempting to contact the down server 8004 do not get a response from the down server 8004. The failure to receive a response from the server 8004 indicates that the server 8004 is down. This information is then stored in the knowledge base of the entire system. More than one server may need to confirm that the server 8004 is down. Through gossip communication among other running servers 8001-8003 and 8005-8099, the down state of the server 8004 is known to all the servers in the masterless WebSocket server system 8000.

For example, if server 8004 goes down and server 8010 randomly selects server 8004 to gossip, server 8010 will not be able to establish a connection with server 8004. Subsequently, server 8010 records in its knowledge base the information that it had trouble connecting to server 8004. Through gossip communication, server 8010 can spread its knowledge base to other servers in the masterless WebSocket server system 8000. Gradually, through gossip communication the servers (e.g. 8001-8003 and 8005-8099) in the masterless WebSocket server system 8000 learns about the down status of the server 8004, since many have trouble connecting to it. Through an API, the client computers can also learn the fact that server 8004 is down and avoid it.

The above example embodiments have been described hereinabove to illustrate various embodiments of implementing a masterless WebSocket servers system. Various modifications and departures from the disclosed example embodiments will occur to those having ordinary skill in the art. The subject matter that is intended to be within the scope of the disclosure is set forth in the following claims.

What is claimed is:

1. A system comprising:
a plurality of client computers; and
a plurality of servers connected to the plurality of client computers over a network,
wherein the plurality of servers include a first number of SEED servers and a second number of non-SEED servers, and
wherein the plurality of servers communicate and exchange network connectivity information with each other through gossip communication.

2. The system of claim 1, wherein the network connectivity information is one or more of a domain name and a static IP address.

3. The system of claim 1, wherein the plurality of servers are WebSocket servers.

4. The system of claim 3, wherein the WebSocket server provides full-duplex communication over a single transmission control protocol (TCP).

5. The system of claim 1, wherein the system detects a down server among the plurality of servers through gossip communication.

6. The system of claim 5, wherein the gossip communication is a communication protocol involving periodic, pairwise, inter-process interactions among the plurality of servers.

7. The system of claim 1, wherein the system adds an additional server to the plurality of servers through gossip communication.

8. The system of claim 1, wherein each server of the plurality of servers periodically and independently communicates with the other servers in the system through gossip communication.

9. The system of claim 1, wherein the network is an Internet.

10. A method comprising:
an originating server accessing network connectivity information of the originating server and one or more SEED servers in a server system;
the originating server saving the network connectivity information of the originating server and the one or more SEED servers in a data base of the server system;
the originating server selecting a destination server among a plurality of servers;
the originating server sending the network connectivity information stored in the data base of the server system to the destination server;
the destination server combining the network connectivity information received from the originating server to the network connectivity information of the destination server;
the destination server returning the combined network connectivity information to the originating server; and
the originating server combining the received network connectivity information from the destination server with the network connectivity information stored in the data base of the server system.

11. The method of claim 10, wherein the network connectivity information provides one or more of a domain name and a static IP address.

12. The method of claim 10, wherein the plurality of servers acts as WebSocket servers to provide full-duplex communication on channels over a single transmission control protocol (TCP).

13. The method of claim 10, wherein the server system detects a down server among the plurality of servers using the communication among the plurality of servers and the network connectivity information stored in the data base.

14. The method of claim 10, wherein the server system adds an additional server to the plurality of servers using the communication among the plurality of servers and the network connectivity information stored in the data base.

15. The method of claim 10, wherein each server of the plurality of servers periodically and independently communicates with other servers in the server system.

16. The method of claim 10, wherein an Internet network is used for the communication among the plurality of servers.
